(19) United States
(12) Patent Application Publication
(10) Pub. No.: US 2015/0001950 A1
(43) Pub. Date: Jan. 1, 2015

(54) APPARATUS FOR TRANSFERRING ELECTROMAGNETIC ENERGY

(71) Applicant: City University of Hong Kong, Kowloon (HK)

(72) Inventors: Shu Hung Henry Chung, Mid-Levels (HK); Nan Chen, Vasteras (SE); Po Wa Jeff Chow, Shatin (HK); Lai Hang Leanne Chan, Kowloon (HK)

(21) Appl. No.: 13/932,353

(22) Filed: Jul. 1, 2013

(51) Int. Cl. H01F 38/14

(52) U.S. Cl. CPC H01F 38/14
USPC 307/104

(57) ABSTRACT

An apparatus for transferring electromagnetic energy includes a coil arrangement operable to transmit magnetic flux to a receiver or to receive magnetic flux from a transmitter, wherein the coil arrangement includes a main coil and at least one auxiliary coil electrically combined with the main coil such that the combination of the main coil and the at least one auxiliary coil is arranged to alter an electromagnetic coupling between the coil arrangement and the transmitter or the receiver to increase an operation alignment range between the coil arrangement and the transmitter or the receiver.

### TECHNICAL FIELD

The present invention relates to an apparatus for transferring electromagnetic energy, and particularly, although not exclusively, to a wireless inductive link arranged to transfer electromagnetic energy.

### BACKGROUND

A wireless inductive link may be used for transmitting electrical power to a device, such as charging a device wirelessly. A wireless inductive link may also be used for wireless communication. In some devices, a wireless inductive link may operates both as an energy link to power up an end-use-device, as well as a communication link to control and retrieve data from the device, using the same set of coupled coils.

A basic wireless inductive link may consist of a transmitter, a receiver, and loosely-coupled coils. Energy is transferred between the transmitter coil and the receiver coil through alternating magnetic fields. However, these include links may be inefficient and may not be able to satisfy the requirement of a high power transfer efficiency or high data transmission rate.

### SUMMARY OF THE INVENTION

In accordance with a first aspect of the present invention, there is provided an apparatus for transferring electromagnetic energy comprising a coil arrangement operable to transmit magnetic flux to a receiver or to receive magnetic flux from a transmitter, wherein the coil arrangement includes a main coil and at least one auxiliary coil electrically combined with the main coil such that the combination of the main coil and the at least one auxiliary coil is arranged to alter an electromagnetic coupling between the coil arrangement and the transmitter or the receiver to increase an operation alignment range between the coil arrangement and the transmitter or the receiver.

In some embodiments, the apparatus is advantageous in that the coil arrangement may operate to improve an electromagnetic coupling between the coil arrangement and a transmitter or receiver. This may, as an example, change or alter the coupling pattern or coupling area so as to enable a larger misalignment tolerance or alignment operating range of the transmitter and receiver which uses the coil arrangement. In some examples, whilst enabling a larger misalignment tolerance, there may be provided an increase in the electromagnetic coupling between the coil arrangement and an associated transmitter or receiver although depending on the operating conditions or circumstances, there may also be a decrease in the electromagnetic coupling to provide this enlargement of the misalignment tolerance.

In an embodiment of the first aspect, each of the main coil and the at least one auxiliary coil is operable to transmit magnetic flux to the receiver or to receive magnetic flux from the transmitter.

In an embodiment of the first aspect, the increased operation alignment range between the coil arrangement and the transmitter or the receiver includes an increased displacement and/or angular alignment between the coil arrangement and the transmitter or the receiver.

In an embodiment of the first aspect, each of the main coil and the at least one auxiliary coil have different spatial orientations.

In an embodiment of the first aspect, the electromagnetic coupling between the coil arrangement and the transmitter or the receiver defines an overall mutual coupling.

In an embodiment of the first aspect, the electrical combination of the main coil and each of the at least one auxiliary coil is interchangeable depending on a misalignment condition between the coil arrangement and the transmitter or the receiver so as to maximize the overall mutual inductance.

In an embodiment of the first aspect, the main coil and the at least one auxiliary coil each defines a plane, the planes being arranged to be defined by one or more intersection of the main coil with the at least one auxiliary coil.

In an embodiment of the first aspect, the main coil and the at least one auxiliary coil are electrically connected in series.

In an embodiment of the first aspect, the main coil and the at least one auxiliary coil are electrically connected in parallel.

In an embodiment of the first aspect, the plane defined by the main coil is orthogonal to at least one of the plane defined by the at least one auxiliary coil.

In an embodiment of the first aspect, the main coil and the auxiliary coil are simultaneously energized.

In an embodiment of the first aspect, the main coil and the at least one auxiliary coil each comprises at least one turn.

In an embodiment of the first aspect, the main coil and the at least one auxiliary coil each resembles a circular, square, rectangular, triangular, polygonal or any irregular shape.

In an embodiment of the first aspect, litz wires are used in the main coil and the at least one auxiliary coil.

In an embodiment of the first aspect, the main coil and/or the at least one auxiliary coil is defined single core wire, multi core wire, printed circuit board (PCB) etching or any combination thereof.

In an embodiment of the first aspect, the coil arrangement defines a first inductance and a first resistance and the transmitter or the receiver defines a second inductance and a second resistance; and the coil arrangement is coupled with the transmitter or the receiver through a third inductance defined by the electromagnetic coupling between the coil arrangement and the transmitter or the receiver.

In an embodiment of the first aspect, a load is connected to the coil arrangement when the coil arrangement is arranged to receive electromagnetic energy from the transmitter.

In an embodiment of the first aspect, the coil arrangement is further connected with a capacitive component arranged to resonate with the first inductance of the coil arrangement on an operating frequency so as to increase an energy transfer efficiency between the coil arrangement and the transmitter.

In an embodiment of the first aspect, the capacitive component is connected in series with the load.

In an embodiment of the first aspect, the capacitive component is connected in parallel with the load.

In an embodiment of the first aspect, each of the at least one auxiliary coil is transposed vertically, horizontally or both vertically or horizontally about an axis of the main coil.

In an embodiment of the first aspect, each of the at least one auxiliary coil is not concentric or coaxial with the main coil.

In an embodiment of the first aspect, the main coil and the at least one auxiliary coil have a spiral, solenoid or rectangular winding structure.

In accordance with a second aspect of the present invention, there is provided a wireless inductive link arranged to transfer electromagnetic energy comprising a receiver and a transmitter, wherein at least one of the transmitter or the receiver is an apparatus in accordance with any embodiment of the first aspect of the present invention.

### BRIEF DESCRIPTION OF THE DRAWINGS

Embodiments of the present invention will now be described, by way of example, with reference to the accompanying drawings in which:

FIG. 1 is a schematic diagram of an apparatus for transferring electromagnetic energy with basic structure of square induction coils;

FIG. 2 is a schematic diagram of an apparatus for transferring electromagnetic energy in accordance with one embodiment of the present invention;

FIG. 3 is a schematic diagram illustrating the variation of mutual inductance under lateral misalignments in the apparatus for transferring electromagnetic energy of FIG. 2;

FIG. 4 is a schematic diagram illustrating an equivalent circuit of a loosely coupled transformer (L₁and r₁ are defined as self-inductance and the total parasitic resistance of primary coil, L₂ and r₂ are used for secondary coil), and M is defined as the mutual inductance;

FIG. 5 is a schematic diagram illustrating an equivalent circuit of a loosely coupled transformer with series resonant-capacitor (v_{L} is the voltage across the load resistance and vᵢₙ is the voltage across the transmitting coil);

FIG. 6 is a schematic diagram illustrating an equivalent circuit of loosely coupled transformer with parallel resonant-capacitor;

FIG. 7A is a plot showing the variation of M of the single parallel receiver coil structure and the proposed coil structure in series coil connection (SCC) under lateral misalignments;

FIG. 7B is a plot showing the variation of M of the single parallel receiver coil structure and the proposed coil structure in series coil connection (SCC) under angular misalignments;

FIG. 8A is a plot showing the comparisons of normalized efficiency η_{pc} between single parallel receiving and cross receiving coil structures with parallel capacitor under lateral misalignments;

FIG. 8B is a plot showing the comparisons of normalized efficiency η_{pc} between single parallel receiving and cross receiving coil structures with parallel capacitor under angular misalignments;

FIG. 9 is a schematic diagram of an apparatus for transferring electromagnetic energy with one embodiment of the present invention;

FIG. 10 is a schematic diagram of an apparatus for transferring electromagnetic energy with Cartesian coordinate system on transmitting and receiving coils;

FIG. 11A is a schematic diagram of an apparatus for transferring electromagnetic energy in accordance with one embodiment of the present invention and with auxiliary coil on XY plane;

FIG. 11B is a schematic diagram of an apparatus for transferring electromagnetic energy in accordance with one embodiment of the present invention and with auxiliary coil on XY plane;

FIG. 11C is a schematic diagram of an apparatus for transferring electromagnetic energy in accordance with one embodiment of the present invention and with auxiliary coil on XY plane;

FIG. 12A is a schematic diagram of an apparatus for transferring electromagnetic energy in accordance with one embodiment of the present invention and with auxiliary coil on YZ plane;

FIG. 12B is a schematic diagram of an apparatus for transferring electromagnetic energy in accordance with one embodiment of the present invention and with auxiliary coil on YZ plane;

FIG. 12C is a schematic diagram of an apparatus for transferring electromagnetic energy in accordance with one embodiment of the present invention and with auxiliary coil on YZ plane;

FIG. 13A is a schematic diagram of an apparatus for transferring electromagnetic energy in accordance with one embodiment of the present invention and with auxiliary coil on XY and YZ plane;

FIG. 13B is a schematic diagram of an apparatus for transferring electromagnetic energy in accordance with one embodiment of the present invention and with auxiliary coil on XY and YZ plane;

FIG. 13C is a schematic diagram of an apparatus for transferring electromagnetic energy in accordance with one embodiment of the present invention and with auxiliary coil on XY and YZ plane;

FIG. 13D is a schematic diagram of an apparatus for transferring electromagnetic energy in accordance with one embodiment of the present invention and with auxiliary coil on XY and YZ plane;

FIG. 13E is a schematic diagram of an apparatus for transferring electromagnetic energy in accordance with one embodiment of the present invention and with auxiliary coil on XY and YZ plane;

FIG. 14A is a schematic diagram of an apparatus for transferring electromagnetic energy in accordance with one embodiment of the present invention and with two auxiliary coils on a same plane;

FIG. 14B is a schematic diagram of an apparatus for transferring electromagnetic energy in accordance with one embodiment of the present invention and with two auxiliary coils on a same plane;

FIG. 14C is a schematic diagram of an apparatus for transferring electromagnetic energy in accordance with one embodiment of the present invention and with two auxiliary coils on a same plane;

FIG. 15A is a schematic diagram of an apparatus for transferring electromagnetic energy in accordance with one embodiment of the present invention and with a circular main coil (MC) and distributed circular auxiliary coils (AC);

FIG. 15B is a schematic diagram of an apparatus for transferring electromagnetic energy in accordance with one embodiment of the present invention and with a circular main coil (MC) and distributed circular auxiliary coils (AC); and

FIG. 15C is a schematic diagram of an apparatus for transferring electromagnetic energy in accordance with one embodiment of the present invention and with a circular main coil (MC) and distributed circular auxiliary coils (AC).

### DETAILED DESCRIPTION OF THE PREFERRED EMBODIMENT

The inventors have, through their own research, trials and experiments, devised that advances in different areas, including materials science, power semiconductor technologies and proliferation of micro-fabrication and nano-fabrication facilitates inexpensive applications, like biomedical electronics, logistics and transportation, evolves research ranges from enhancing system power management to augmenting data transmission.

Transmitter and receiver designs have a link efficiency problem which may be determined by a fundamental “bottleneck”—fluctuations in the power transfer and link efficiency due to misaligned positions of the coupled coils. When the coils are coaxially orientated, there is magnetic coupling between the coils and thus the link efficiency are maximal. However, if the two coils are misaligned the magnetic coupling and the overall link efficiency will impair significantly.

Wireless inductive power links have been widely applied in different applications such as cochlear implants, retinal prostheses, and battery charger. In general, the system is composed of a transmitter, an end-use device, and two sets of loosely-coupled coils with one set in the transmitter, and one set in the end-use device. Electrical energy is transmitted from the transmitter to the device through alternative magnetic fields. Then, under a given operating frequency, maximal power efficiency η of coupled coils is dependent on the quality factors of the primary and secondary coils, Q₁ and Q₂, and the coupling coefficient k between the coils, as shown in equation

$$η = \frac{{k}^{2} {Q}_{1} {Q}_{2}}{{[ 1 + \sqrt{1 + {k}^{2} {Q}_{1} {Q}_{2}} ]}^{2}} \qquad ( 1 )$$

When coils are operating in high-frequency, frequency-related effects including skin effect and proximity effect will degenerate their quality factors. Coupling coefficient k measures the degree of magnetic coupling. Its value ranges from 0 to 1. When k=0, flux linkage is zero. When k=1, flux linkage is 100%.

$$k = \frac{M}{\sqrt{{L}_{1} {L}_{2}}} \qquad ( 2 )$$

M is mutual inductance between the coils and it is determined by the coil sizes and geometric spacing. When the coils are coaxially oriented, the coupling is the strongest. However in practice, they are usually misaligned axially, laterally and angularly so that their linkage will be impaired. Taking retinal prostheses as an example, axial and lateral misalignment will occur for displacements of the pair of glasses, whereas angular misalignment will occur for rotations of the eye. A fundamental problem is that the fluctuations in coupling due to misaligned positions of the coils lead to a large variation in power efficiency.

To maximize misalignment tolerance for disk-shaped primary coil, in some embodiments, the primary coil diameter should be larger than that of secondary coil and equal to twice the distance between two coils. However, these embodiments have several drawbacks. There is a large portion of magnetic flux generated by an oversized transmitter that is uncoupled to the receiving coil for misaligned conditions and even aligned conditions. The excess flux may cause a problem of electromagnetic radiation.

As an example, coil structures like multi-layer planar windings and three-dimensional (3-D) windings may enhance magnetic coupling and energy transfer on misaligned coils. The former one is introduced in 2-D applications so it is not designed to tackle angular misalignments. The latter one can only offer pseudo-omnidirectional coupling which is an effectively single-coil-to-single-coil coupling. It results in a weak coupling zone around some positions.

An embodiment of a receiver structure with an additional orthogonal coil on conventional receiving coil is shown and described in the example below. This embodiment may be advantageous in that, in at least one example, the impact of misalignment on the power efficiency is minimized.

Given fixed coil configurations, the power efficiency increases with the mutual inductance M between the transmitting coil and the receiving coil. The mutual inductance is defined as the number of flux linkage with the secondary coil due to unit current in primary coil and it can be calculated by Neumann formula. Empirically, it is advantageous to align the receiving coil orthogonally to the magnetic flux generated by the transmitting coil to achieve the maximum flux linkage between the coils. However, in many practical applications, like implantable devices, the two coils position between each other is not fixed, they could have combined axial, lateral and angular misalignment. The resulting mutual inductance between the coils will be affected considerably. In this following discussion, lateral and angular misalignments between square shaped coils are given.

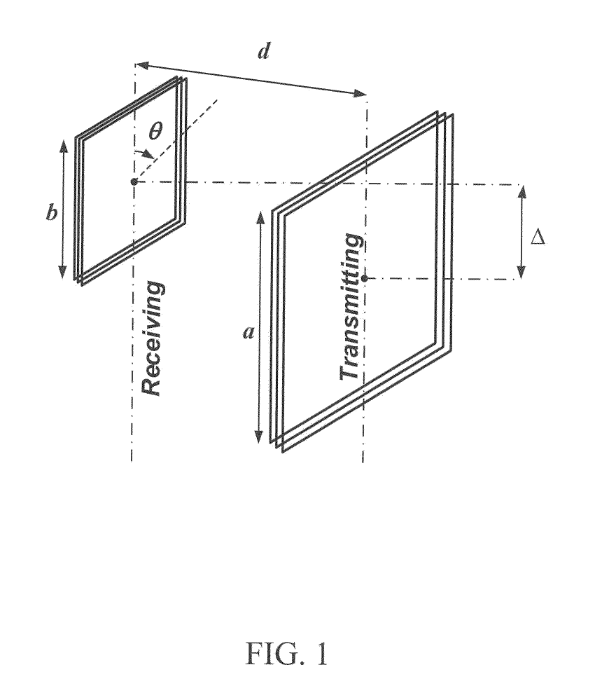

FIG. 1 illustrates two square coils under misalignments, in which Δ represents the displacements from their centres and θ represents the angle between the planes of the two coils. The mutual inductance and energy efficiency of this coil configuration will decrease quickly toward zero when the misalignment increases.

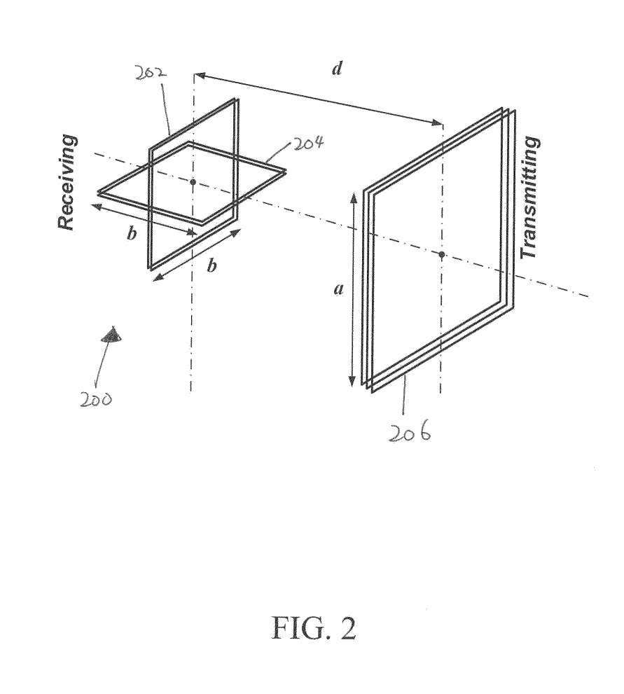

Referring to FIG. 2, there is shown an apparatus for transferring electromagnetic energy comprising a coil arrangement 200 operable to transmit magnetic flux to a receiver or to receive magnetic flux from a transmitter 206, wherein the coil arrangement includes a main coil 202 and at least one auxiliary coil 204 electrically combined with the main coil such that the combination of the main coil 202 and the at least one auxiliary coil 204 is arranged to alter an electromagnetic coupling between the coil arrangement and the transmitter 206 or the receiver to increase an operation alignment range between the coil arrangement and the transmitter 206 or the receiver.

Preferably, each of the main coil 202 and the at least one auxiliary coil 204 is operable to transmit a magnetic flux linkage to the receiver or to receive a magnetic flux linkage from the transmitter 206. The increased operation alignment range may include an increased displacement and/or angular alignment between the coil arrangement 200 and the transmitter 206 or the receiver, which is an essential parameter for improving the transmission coupling and hence increasing the efficiency of the transmission link.

In a preferred embodiment, as shown in FIG. 2, a receiving coil 200 includes parallel windings 202 and orthogonal windings 204 as the main coil and the auxiliary coil, and is operable to reduce the variation of mutual inductance in the presence of misalignment. These two coils may have the same dimensions and total number of turns. Alternatively, the main coil 202 and the auxiliary coil 204 may have a different spatial orientation other then orthogonal orientation, or a same spatial orientation. In some examples, the position of main coil 202 and the auxiliary coil 204 may also not be concentric with each other. In this example, the centers of main coil 202 and the at least one auxiliary coils 204 may be at different position. As a result, one or more auxiliary coils 204 may be arranged to upper or lower the middle height of the main coil 202, effectively, as in some examples, the main and auxiliary coils have different spatial coordinates such as in the case where the auxiliary coils 204 is transposed either vertically, horizontally and/or both along an axis of the main coil. In this way, the one or more auxiliary coils may not be concentric or coaxial with the main coil.

The main coil 202 and the auxiliary coil 204 may also have different dimensions or different number of turns. Each of the main coil 202 and the auxiliary coil 204 have at least one turn, and the main coil 202 and the auxiliary coil 204 each may resemble a circular, square, rectangular, triangular, polygonal or any other irregular shape.

Preferably, the main coil 202 and the at least one auxiliary coil 204 each defines a plane, the planes defined by of each of the main coil 202 and the at least one auxiliary coil 204 intersect each other. Optionally, the plane defined by the main coil 202 is orthogonal to at least one of the plane defined by the at least one auxiliary coil 204.

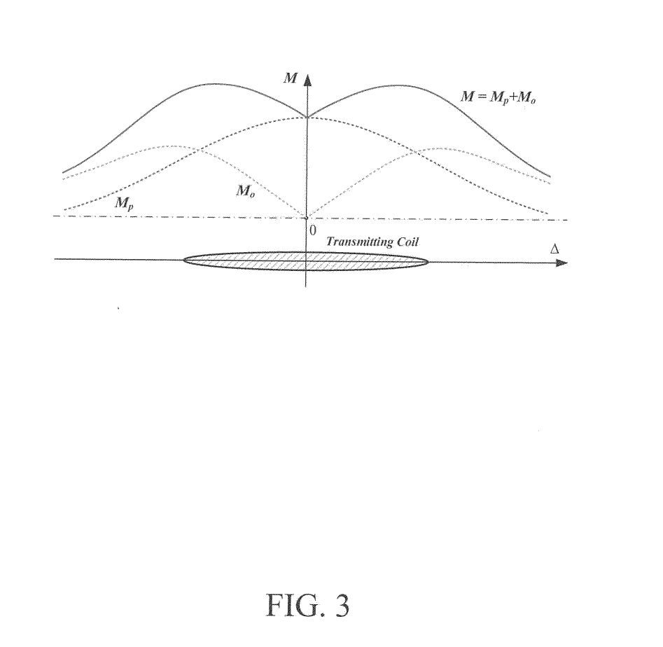

A transmitter coil arrangement is operable to generate and transmit a magnetic flux linkage, where a receiver coil arrangement is operable to electromagnetically couple to the transmitter coil arrangement within an operation alignment range between the coil arrangements, and to induce and receive the transmitted magnetic flux linkage. Referring to FIG. 3, symbol Mₚ represents the mutual inductance between transmitting windings 206 and receiving parallel windings 202 (main coil). Symbol Mₒ is defined as the mutual inductance between transmitting windings and receiving orthogonal windings 204 (auxiliary coil).

Preferably, the electrical connection of the main coil 202 and each of the at least one auxiliary coil 204 is interchangeable depending on a misalignment condition between the coil arrangement and the transmitter or the receiver so as to maximize the overall mutual coupling. In one embodiment, to assure that the overall mutual inductance M is always the absolute sum of Mₚ and M, the circuit connection between the parallel windings 202 (main coil) and orthogonal windings 204 (auxiliary coil) may be interchanged according to the misalignment conditions. Thus Mₒ would be positive for all misalignment conditions. FIG. 3 illustrates the variation of Mₒ and M under the interchanged series connection of the two receiving windings. When the coils (200, 206) are aligned perfectly, Mₚ and Mₒ are maximized and minimized respectively. While the misalignment increases, Mₚ drops but Mₒ rises up and then declines slowly. Therefore, the overall transmitter-receiver mutual coupling becomes more even and more tolerable for misalignments.

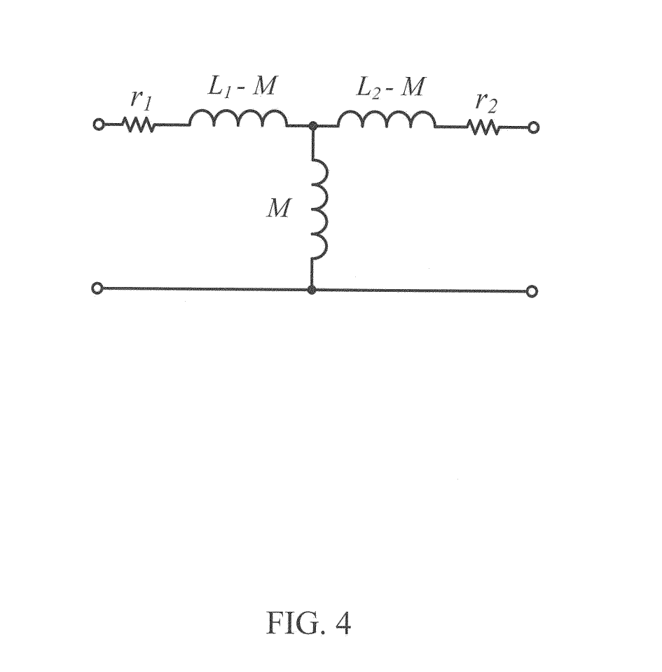

Preferably, the wireless inductive link can be modeled as a loosely-coupled transformer. Referring to FIG. 4, there is shown an equivalent circuit model of a loosely-coupled transformer. There are two possible coil connections for the receiving coil 200. Preferably, the parallel windings 202 are connected in series with the orthogonal windings 204 (e.g. series coil connection (SCC)). Alternatively, the parallel windings 202 are connected in parallel with the orthogonal windings 204 (e.g. parallel coil connection (PCC)). The parallel coil 202 and orthogonal coil 204 have the same structure and the position between them is fixed orthogonally. Hence, the mutual inductance between them is zero, their equivalent inductance and resistance are defined as L and r. Lₜᵣ and rₜᵣ are used for the transmitter coil 206.

In some preferable embodiments, particularly where the apparatus is used as a transmitter, the main coil and the auxiliary coil may be energized at the same time, that is both the main coil and the at least one auxiliary coil may be energized simultaneously or substantially simultaneously.

In some embodiments, the apparatus is advantageous in that the coil arrangement 200 may operate to improve an electromagnetic coupling between the coil arrangement and a transmitter or receiver. This may, as an example, change or alter the coupling pattern or coupling area so as to enable a larger misalignment tolerance or alignment operating range of the transmitter and receiver which uses the coil arrangement 200. In some examples, whilst enabling a larger misalignment tolerance, there may be provided an increase in the electromagnetic coupling between the coil arrangement and an associated transmitter or receiver although depending on the operating conditions or circumstances, there may also be a decrease in the electromagnetic coupling to provide this enlargement of the misalignment tolerance.

In one embodiment, a coil structure 200 is implemented with the parameters as shown in Table I, which provides the transformer model parameters of the coil structure in series and parallel connections.

TABLE I
THE TRANSFORMER MODEL PARAMETERS WITH DIFFERENT
CONNECTIONS

| Series coil connection | Parallel coil connection |
|---|---|
| (SCC) | (PCC) |
| M = Mₚ + Mₒ | $M = \frac{{M}_{p} + {M}_{o}}{2}$ |
| L₁ = Lₜᵣ | ** L₁ ≈ Lₜᵣ |
| r₁ = rₜᵣ | ** r₁ = rₜᵣ |
| L₂ = 2L | ${L}_{2} = \frac{L}{2}$ |
| r₂ = 2r | ${r}_{2} = \frac{r}{2}$ |

** The approximations can be applied since L >> |Mₚ − Mₒ|.

Optionally, a load is connected to the coil arrangement 200 when the coil arrangement 200 is arranged to receive electromagnetic energy from the transmitter 206.

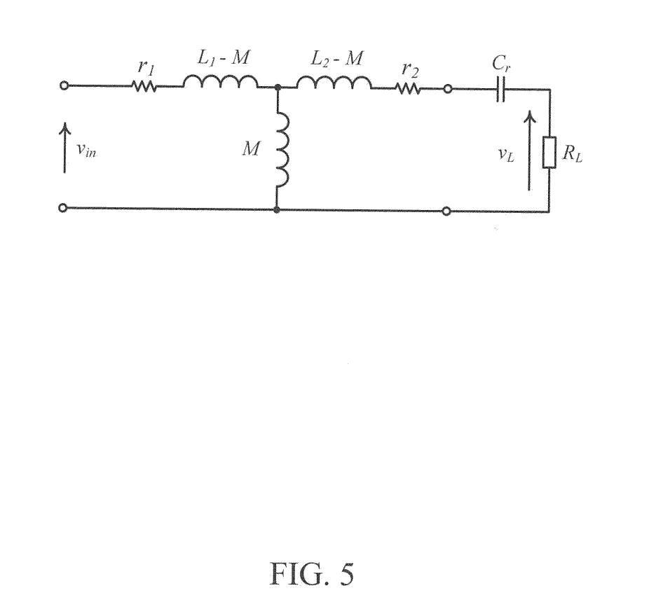

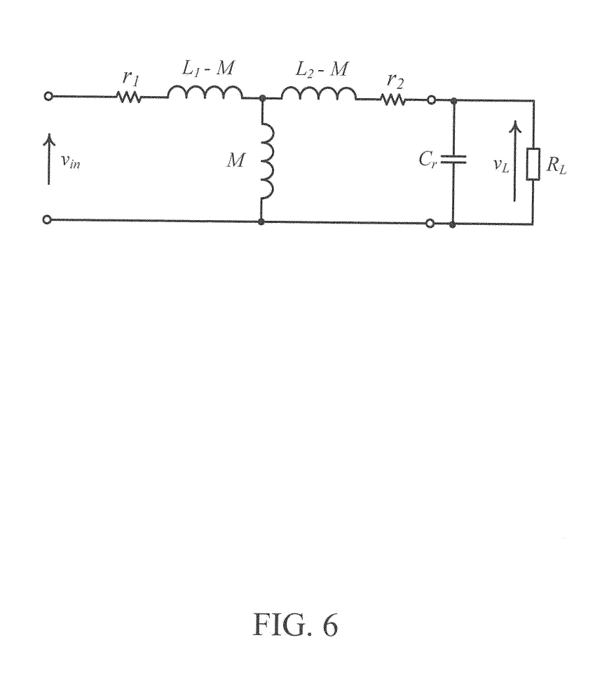

Preferably, to improve the efficiency of the power transfer link, a resonant capacitor, in some embodiments, Cᵣ, is connected to the receiving coil 200 to reduce the effect of the leakage inductance of the coils. The capacitance is designed to resonate with the secondary winding inductance on operating frequency. Cᵣ is either in the form of series or parallel connections, as shown in FIGS. 5 and 6, respectively.

$${C}_{r} = \frac{1}{{ω}^{2} {L}_{2}} \qquad ( 3 )$$

In the following analysis, the load is represented by a resistor R_{L}. The link efficiency η is defined as follows,

$$η = \frac{{P}_{L}}{{P}_{in}} \qquad ( 4 )$$

where Pᵢₙ and P_{L} are the input power on the transmitting coil 206 and output power on the load resistor, respectively.

Referring to FIG. 5, there is shown an equivalent circuit model of a loosely-coupled transformer with series resonant-capacitor. The power efficiency can be shown to be

$${η}_{sc} = \frac{{( ω M )}^{2} {R}_{L}}{{( {R}_{L} + {r}_{2} )}^{2} {r}_{1} + {( ω {L}_{2} - \frac{1}{ω {C}_{r}} )}^{2} {r}_{1} + {( ω M )}^{2} ( {R}_{L} + {r}_{2} )} \qquad ( 5 )$$

When the coil electrical characteristic and excitation frequency are designed, optimal load resistance for maximum power efficiency can be derived as

$${R}_{L , sc} = \sqrt{{r}_{2}^{2} + {( ω M )}^{2} \frac{{r}_{2}}{{r}_{1}}} \qquad ( 6 )$$

Alternatively, with reference to FIG. 6, there is shown an equivalent circuit model of a loosely-coupled transformer with parallel resonant-capacitor. The power efficiency can be shown to be

$${η}_{pc} = \frac{\frac{{( ω M )}^{2} {R}_{L}}{{( ω {C}_{r} {R}_{L} )}^{2} + 1}}{[ \begin{matrix}{{r}_{1} ( \frac{{R}_{L}}{{( ω {C}_{r} {R}_{L} )}^{2} + 1} + {r}_{2} )}^{2} + \frac{{( ω M )}^{2} {R}_{L}}{{( ω {C}_{r} {R}_{L} )}^{2} + 1} \\ + {( {L}_{2} - \frac{{C}_{r} {R}_{L}^{2}}{{( ω {C}_{r} {R}_{L} )}^{2} + 1} )}^{2} {ω}^{2} {r}_{1} + {( ω M )}^{2} {r}_{2}\end{matrix} ]} \qquad ( 7 )$$

Optimal load resistance can be derived as

$${R}_{L , pc} = ω {L}_{2} \sqrt{\frac{{r}_{1} {r}_{2}^{2} + {{r}_{1} ( ω {L}_{2} )}^{2} + {{r}_{2} ( ω M )}^{2}}{{r}_{1} {r}_{2}^{2} + {{r}_{2} ( ω M )}^{2}}} \qquad ( 8 )$$

According to (6) and (8), the load with parallel capacitor is relatively appropriate for larger resistive load application.

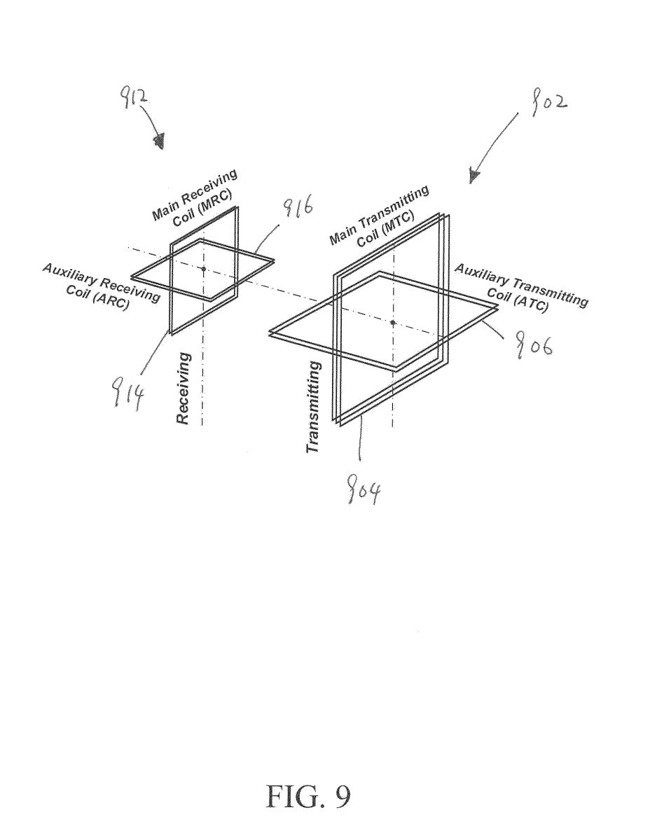

In another embodiment, each coil set can be its main coils and auxiliary coils. That is, the transmitting coil set 902 has main transmitting coil (MTC) 904 and auxiliary transmitting coil (ATC) 906. The receiving coil set 912 has main receiving coil (MRC) 914 and auxiliary receiving coil (ARC) 916. The auxiliary coils (906, 916) are added in a way to improve the coupling between the transmitting 902 and receiving coil sets 912, depending on the structural arrangement of the coil sets. The figure shown in FIG. 9 illustrates that the MTC 904 and MRC 914 are the same as the traditional loosely-coupled transformer. The ARC 916 and ATC 906 are the orthogonal windings for improving the inductive coupling.

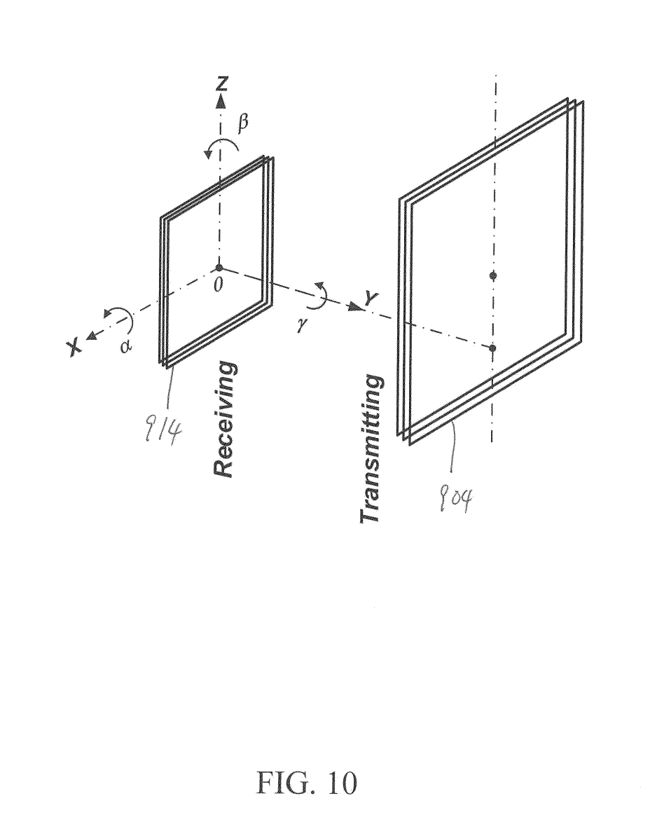

Referring to FIG. 10, there is shown a Cartesian coordinate system on transmitting and receiving coils. The center of each coil is chosen as the reference. The center of the MRC 914 is taken as the origin ‘O’. The lateral misalignment is equivalent to the relative position between MTC 904 and MRC 914 on the XZ plane, and the distance between the centers of MTC 904 and MRC 914 projected on the Y-axis remains unchanged. The angular misalignment occurs when any angle between MTC 904 and MRC 914 along axes X, Y, and Z is non-zero. Symbols α, β, and γ represent the angles between MTC 904 and MRC 914 along X, Z and Y axes, respectively. To improve inductive coupling in one embodiment, auxiliary windings are used. Examples embodiments are described in more detailed as follows.

In an alternative embodiment, two separate sets of main coils and an at least one auxiliary coils forms a transmitter and a receiver, and a wireless inductive link is arranged to transfer electromagnetic energy comprising a receiver and a transmitter

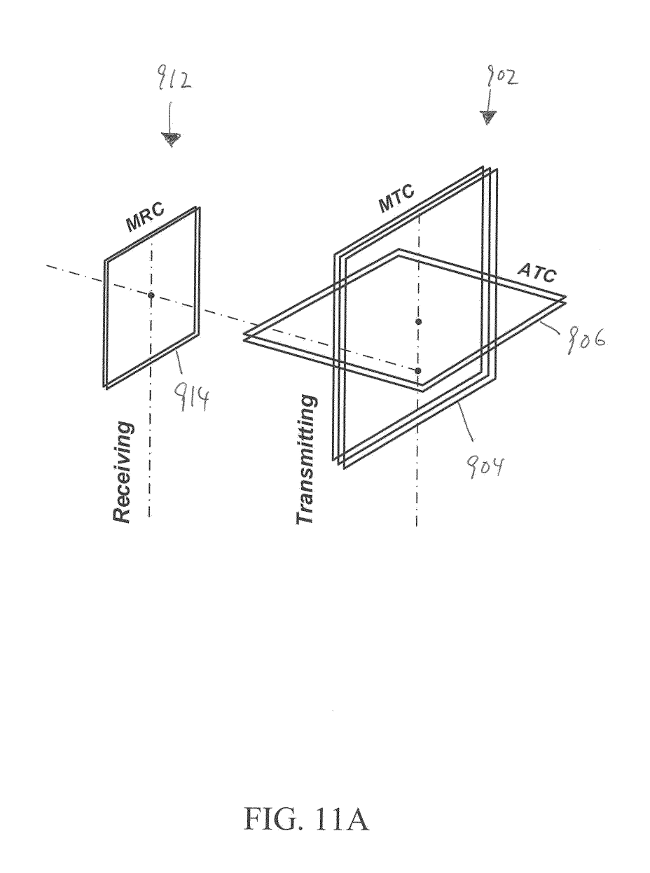

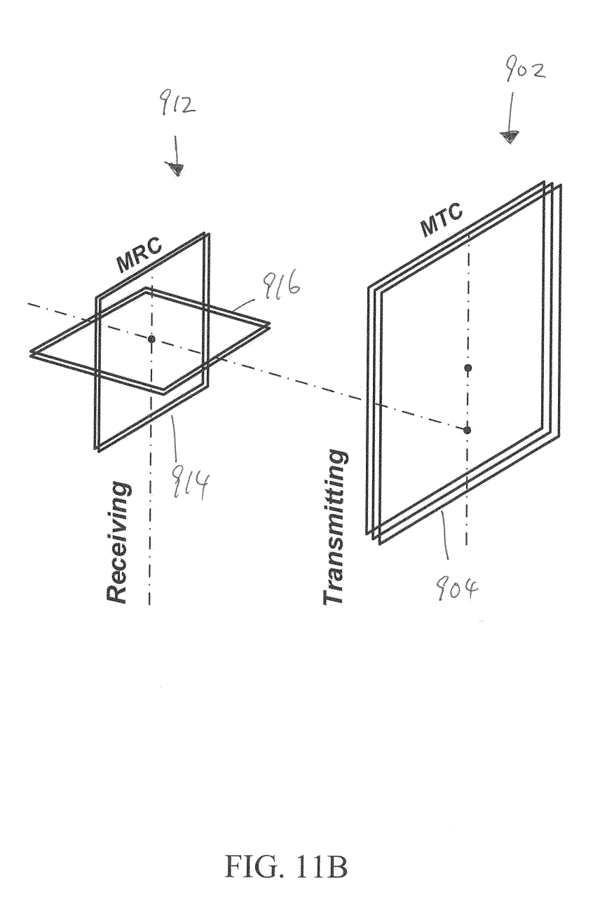

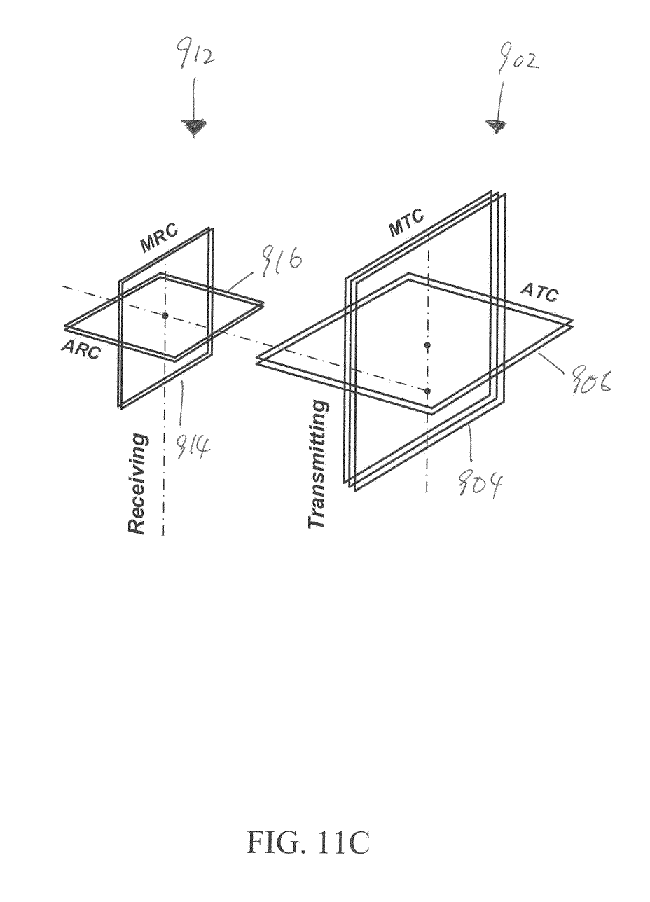

With reference to FIG. 11A to 11C, under lateral misalignment along Z axis and/or angular misalignment of angle α, auxiliary coil(s) on XY plane can be added to the transmitting coil set 902 and/or receiving coil set 912. Preferably, as shown in FIG. 11A, an ATC 906 is added. Alternatively, as shown in FIG. 11B, an ARC 916 is added. Alternatively, as shown in FIG. 11C, both ATC 906 and ARC 916 are added.

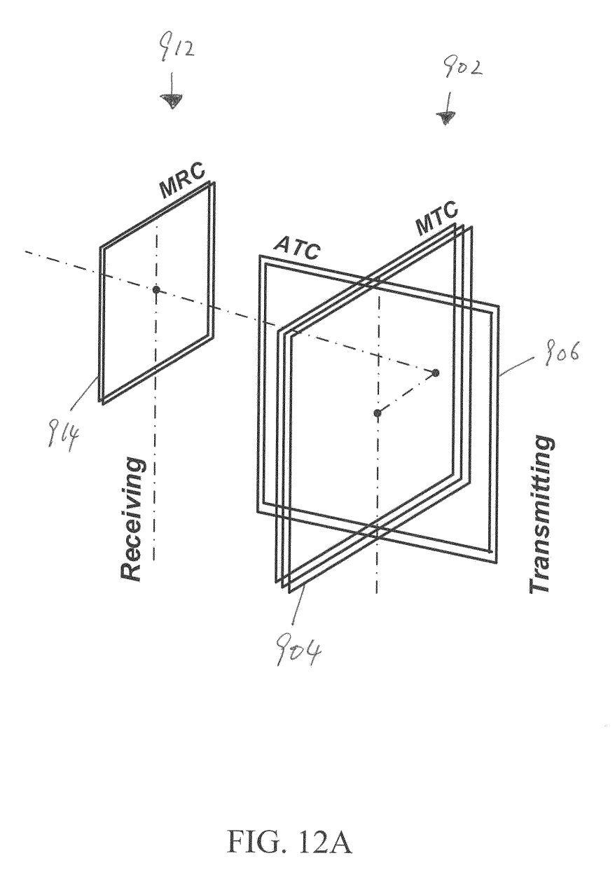

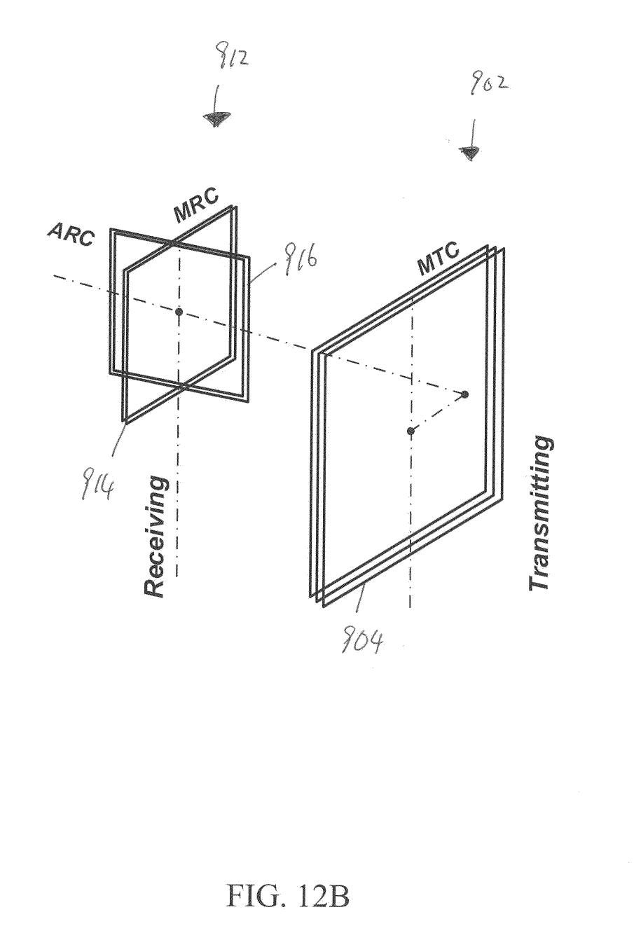

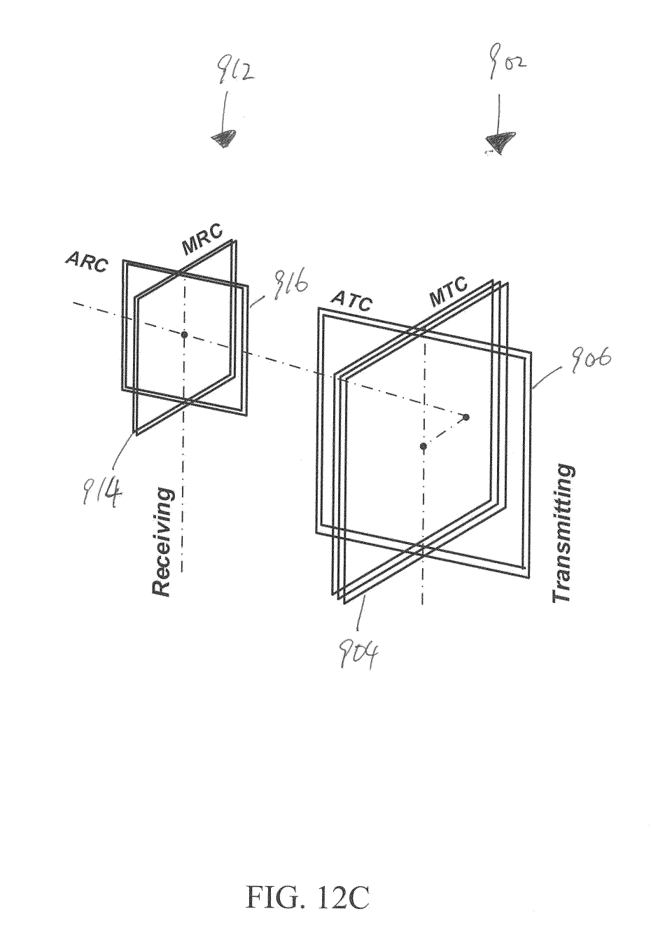

With reference to FIG. 12A to 12C, under lateral misalignment along X axis and/or angular misalignment of angle β, auxiliary coil(s) on ZY plane can be added to the transmitting coil set 902 and/or receiving coil set 912. Preferably, as shown in FIG. 12A, an ATC 906 is added. Alternatively, as shown in FIG. 12B, an ARC 916 is added. Alternatively, as shown in FIG. 12C, both ATC 906 and ARC 916 are added.

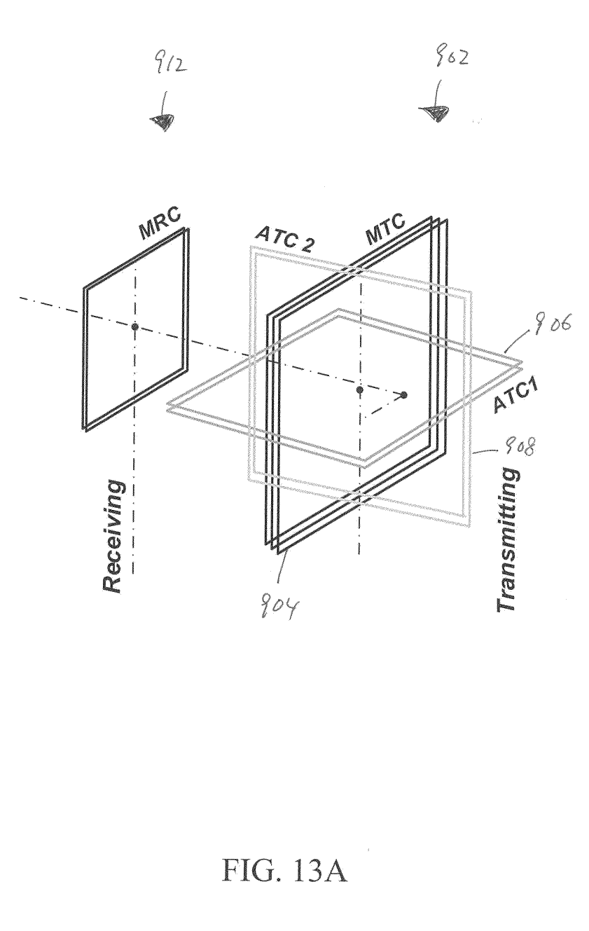

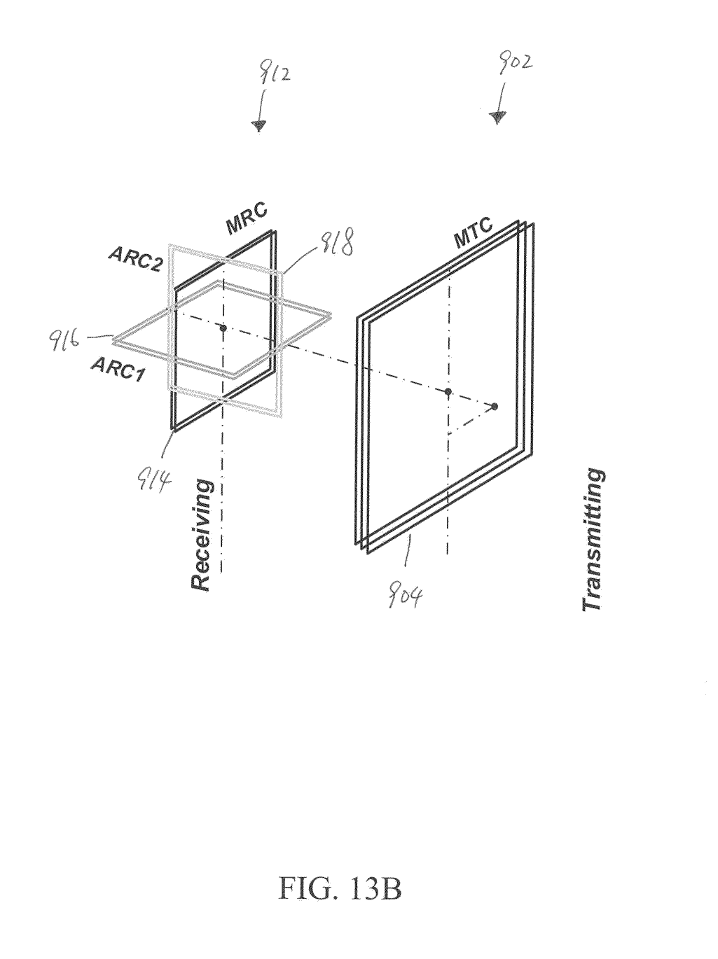

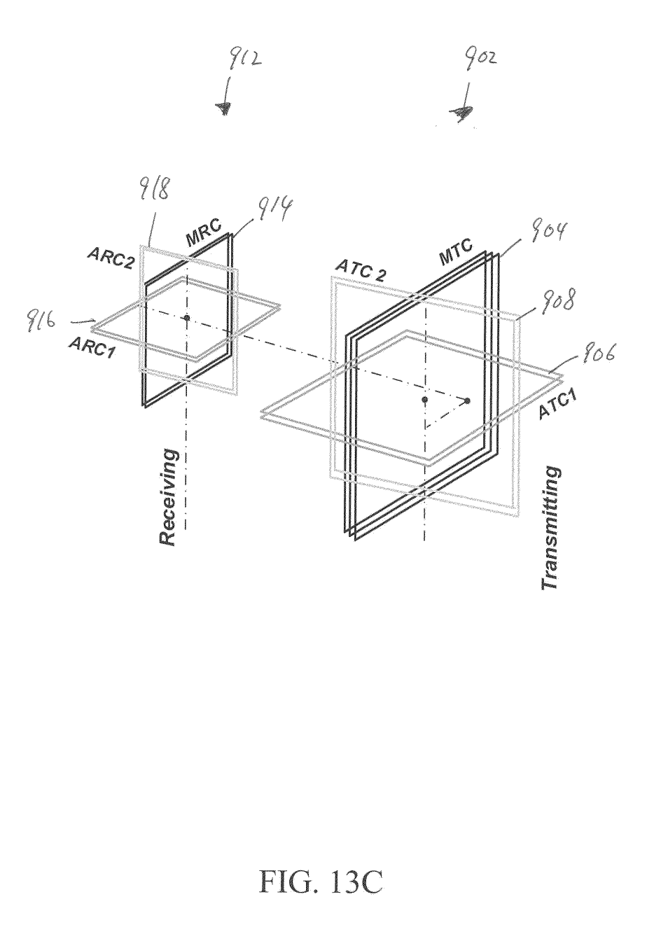

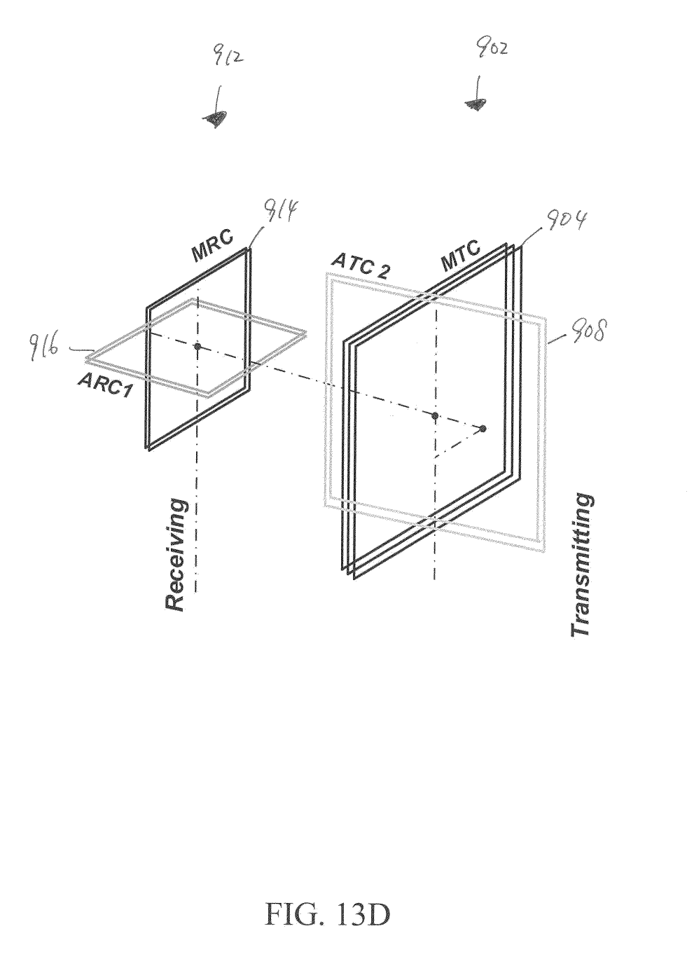

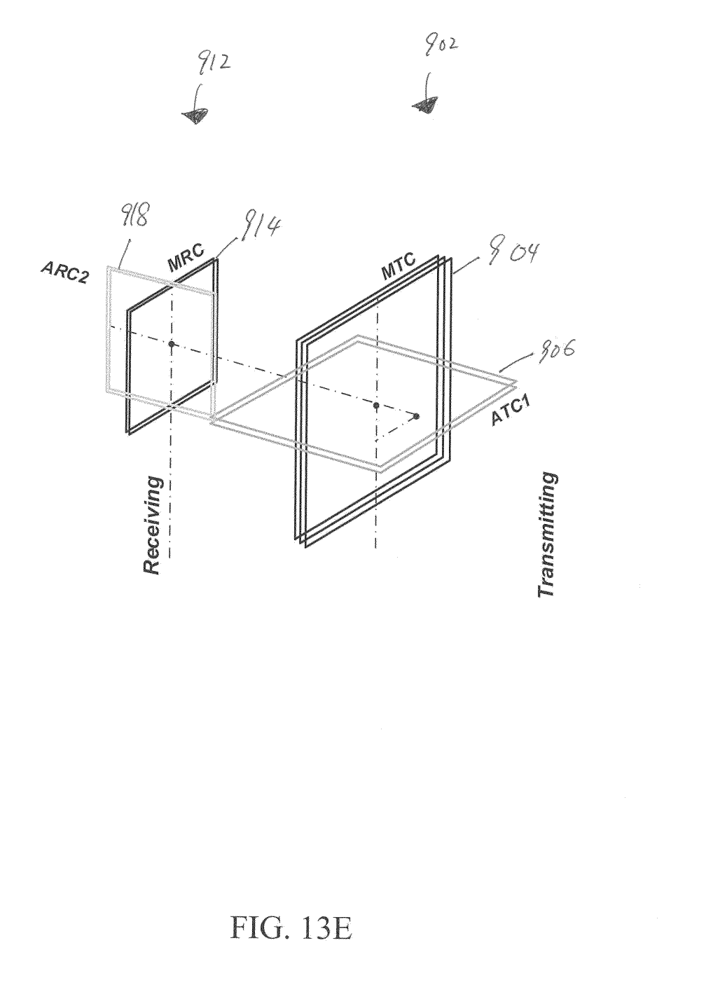

With reference to FIG. 13A to 13E, under the above two misalignment conditions, lateral misalignment along Z and X axes and/or angular misalignment of angle α and β, two sets of auxiliary windings should be applied. The first auxiliary coils, ATC1 906 and ARC1 916, should lie on XY plane of MTC 904, MRC 914, or both. The second auxiliary coils, ATC2 908 and ARC2 918, should lie on ZY plane of MTC 904, MRC 914, or both.

Alternatively, the auxiliary coils are not constrained by their winding structure, shape, dimension, number of turns, position and orientation. The winding structure can be spiral, solenoid, rectangular or printed coil. The shape of the above mentioned coils, including MTC, ATC, MRC, and ARC, can be different. They are allowed to be square, rectangular, triangular, circular elliptical, polygonal, spiral or even irregular shape. Both the winding turns and dimensions of the auxiliary coil are not limited and can be larger or smaller than that of the main coils. It is not necessary for their positions to be concentric with the main coil sets. When the range of misalignment is unsymmetrical, the appropriate position will be shifted away from the main coil center. Since the shape can be irregular, the resulting auxiliary coil may lie on more coordinate planes. The orientation is not restricted to be orthogonal as well. It can be any angle, less than or larger than 90 degree, which is depending on the variation of the angular misalignment or can be transposed horizontally, vertically or both about an axis of either coil such that the main and auxiliary coils are not concentric or coaxial.

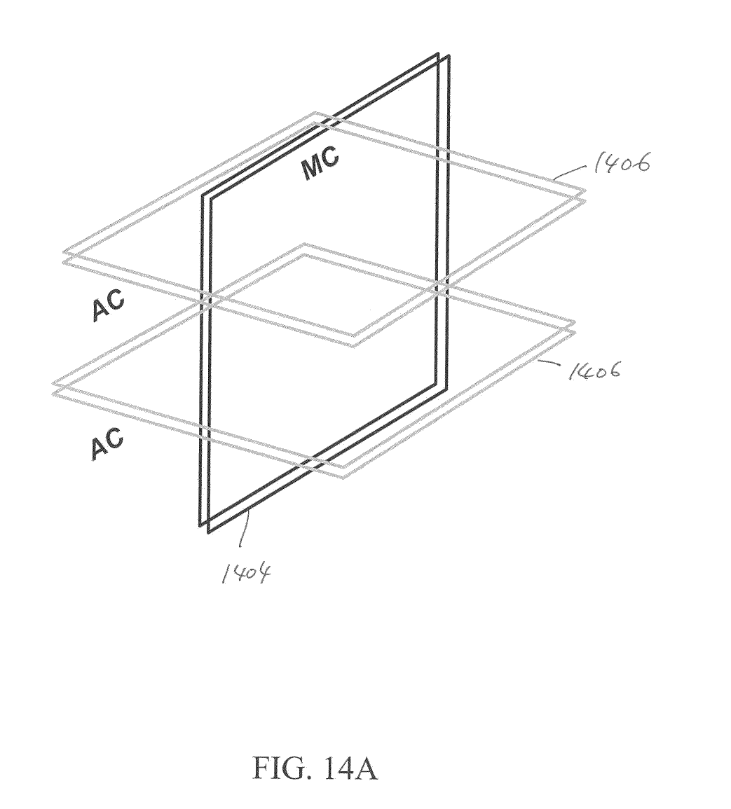

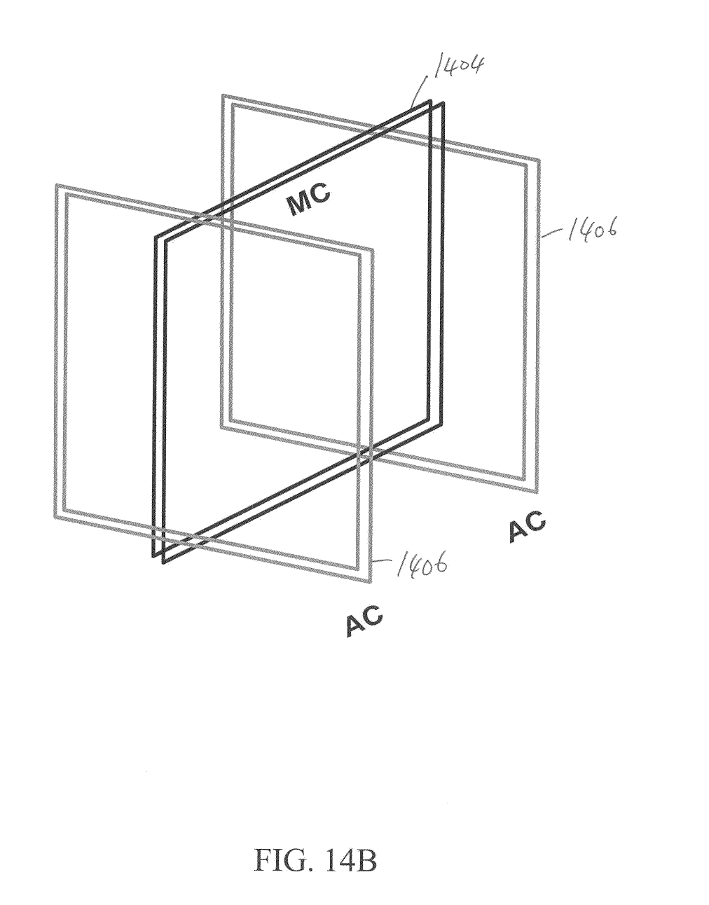

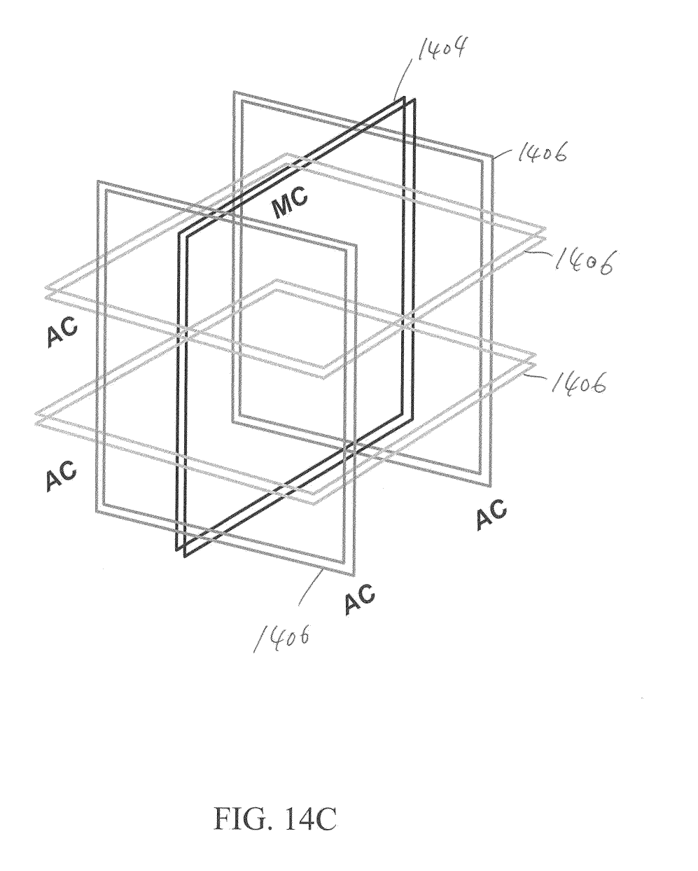

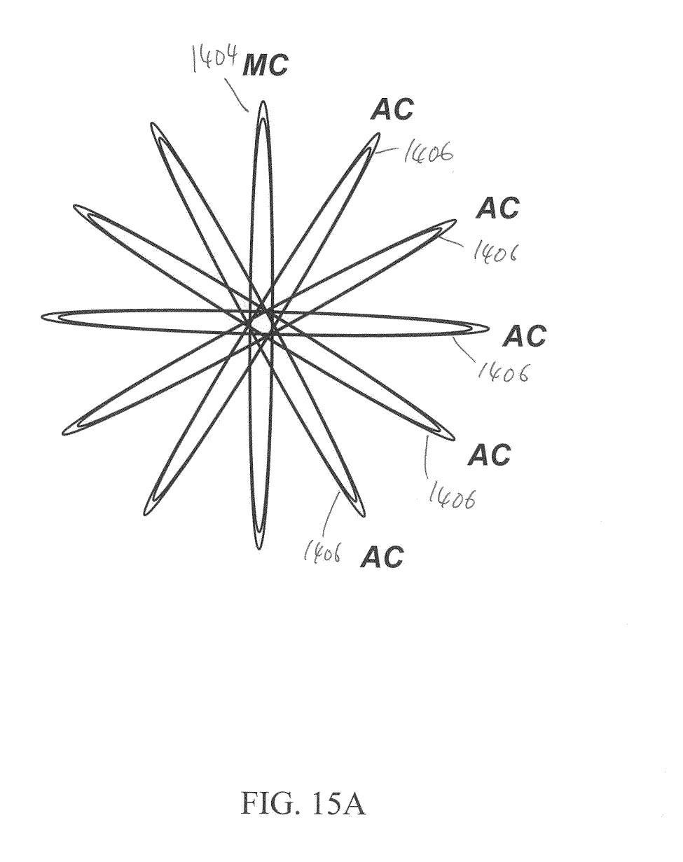

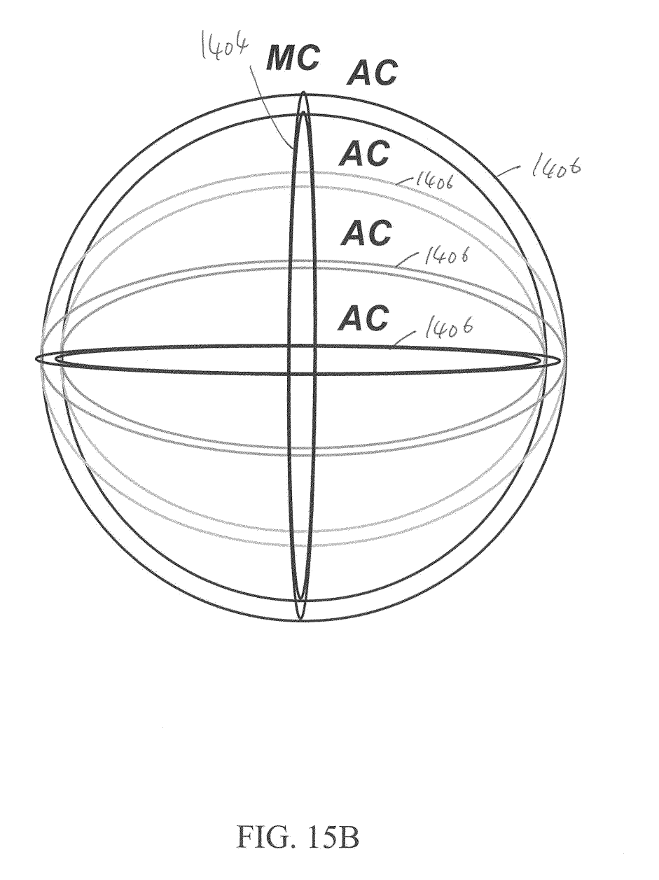

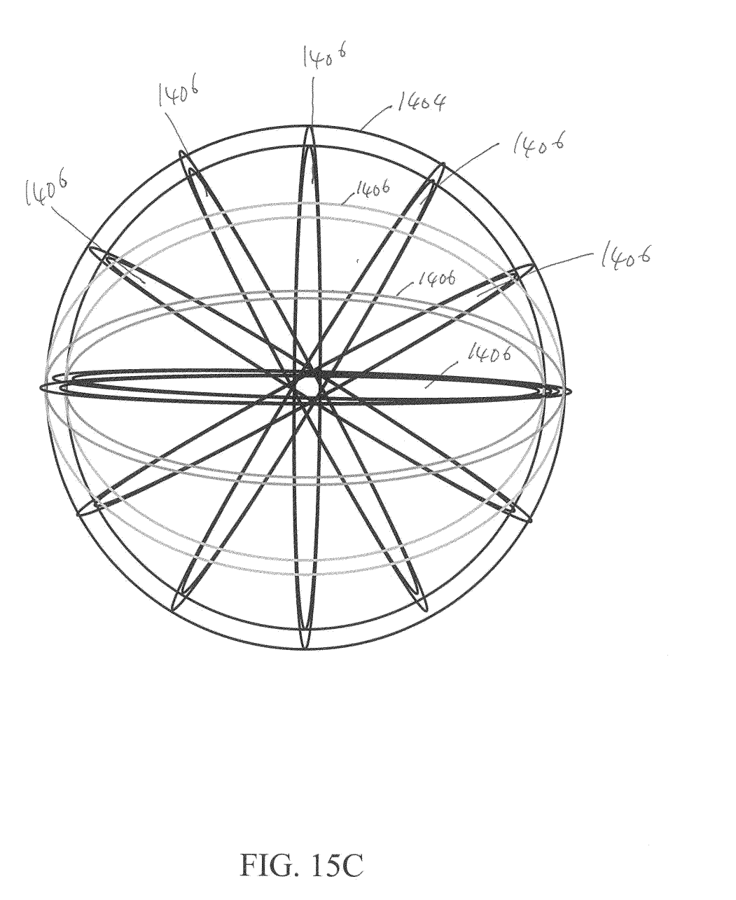

Preferably, to further reduce the variation of mutual inductance and power transfer efficiency under misalignment conditions, there can insert more than one auxiliary coil 1406 on the same coordinate plane so the number and the position of auxiliary coils 1406 should have no limitation. FIG. 14A to 14C illustrate some of the coil structures for both transmitting and receiving coils designs. In these embodiments, there may not be any limitation on the orientation of auxiliary coil and thus the number, position and orientation of auxiliary coils, such as the one shown as 1406 have no limitation. In some embodiments, with reference to FIG. 15A to 15C, the method is applied on circular coil, spherical windings will be obtained finally.

Advantageously, the apparatus for transferring electromagnetic energy enhance the performance of inductive coupling links with air-coupled coils by increasing the electromagnetic coupling between the coil arrangements between a transmitter or a receiver. It uses high-dimensional winding structures, including two-dimensional and three-dimensional windings, to provide true omnidirectional control of magnetic coupling between coils by concurrently energizing each individual coil with appropriate amount of power. Accordingly, some embodiments may offer a number of advantages:

1. The link efficiency is maximized at all time, even under the misalignment condition, because the magnetic coupling between coils can be controlled with high maneuverability and flexibility. This can thus minimize the required power rating of the transmitter and power dissipation of the entire system.

2. Electromagnetic radiation to free space, and thus electromagnetic interference, is reduced with controllable magnetic field distribution.

3. With multiple coils in the n-D structure, it is possible to use multiple carriers to achieve better power transfer and data transmission performance. Thus, high bandwidth data transmission can be achieved without compromising the power transmission.

4. The size of the transmitting coil can be made smaller because it is unnecessary to use a large ratio between the size of the transmitter coil and receiver coil, as in conventional approach, to deal with coil misalignment. Then, this can also minimize the power rating of the transmitter and increase the link efficiency, as the winding resistance will be reduced.

In the example embodiment as shown in FIGS. 1 and 2, an embodiment of an experimental prototype (figure not shown) consisting of these two setups are built for experimental verification. The geometric parameters of two transceiver coil setups shown in FIGS. 1 and 2 are listed in Table II.

TABLE II
THE GEOMETRIC PARAMETERS OF
THE SQUARE INDUCTION COILS.

| | | | Number of turns | | |
|---|---|---|---|---|---|
| | | | | Receiving | Receiving |
| a/cm | b/cm | d/cm | Transmitting | (Parallel) | (Orthogonal) |
| 4.3 | 2.2 | 3 | 20 | 12 | 0 |
| 4.3 | 2.2 | 3 | 20 | 6 | 6 |

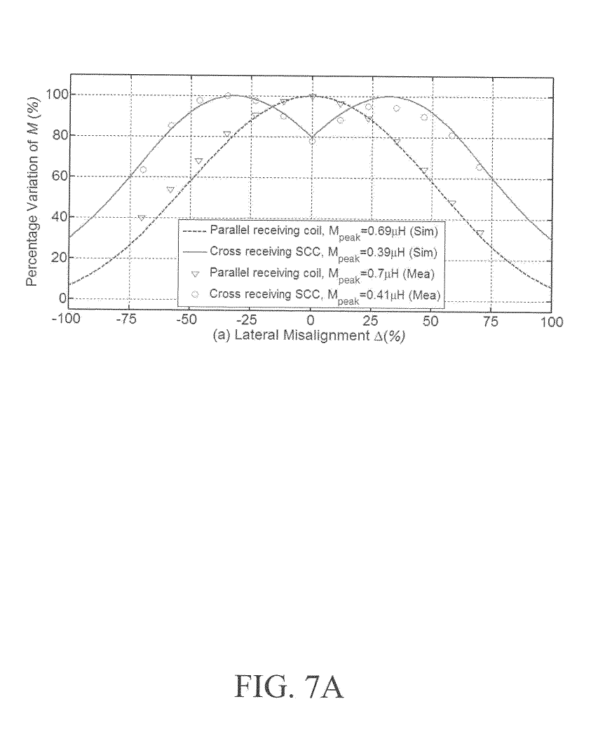

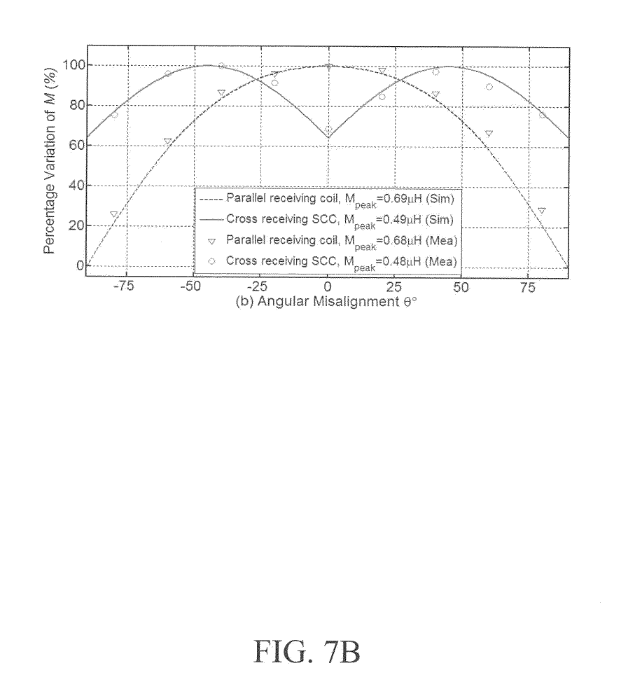

By theoretical calculation and experimental measurements, the percentage variation in M of the cross receiving coil in both SCC and PCC are the same. Thus, only the results of SCC are given in FIGS. 7A and 7B. FIG. 7A gives the measured and calculated percentage variation of M with θ=0° against the lateral misalignment. FIG. 7B shows the percentage variation of M with Δ=0 cm against the angular misalignment. The mutual inductance of the structure of the embodiment is reduced to 60%, when the two coils are displaced laterally by 75% with respect to the transmitting coil diameter or displaced angularly by around 90°. Compared to traditional single parallel receiver design, the new design can afford a wider misalignment range for the given normalized M variation band.

Preferably, to reduce the coil resistance, litz wire is used in this example of the winding coils, although other forms of wire such as single core wire, multi core wire, printed circuit board (PCB) etched tracks or any suitable conductor or conductive medium may also be used. In some other embodiments, either or both the mail coil or the auxiliary coil may be in the form of a printed board or spiral solenoid.

The equivalent inductance and resistance of transmitting coil in 2.2 MHz excitation are 39.06 μH and 10.31Ω respectively. The electrical parameters of three different receiving coils are listed in Table III.

TABLE III
THREE SETS OF COIL PARAMETERS
USED IN BELOW ANALYSIS.

| | L₂/μH | r₂/Ω | Cᵣ/pF |
|---|---|---|---|
| Single parallel receiving coil | 7.29 | 2.64 | 706 |
| Cross receiving coil in series | 3.84 | 1.57 | 1337 |
| Cross receiving coil in parallel | 1.07 | 0.56 | 4858 |

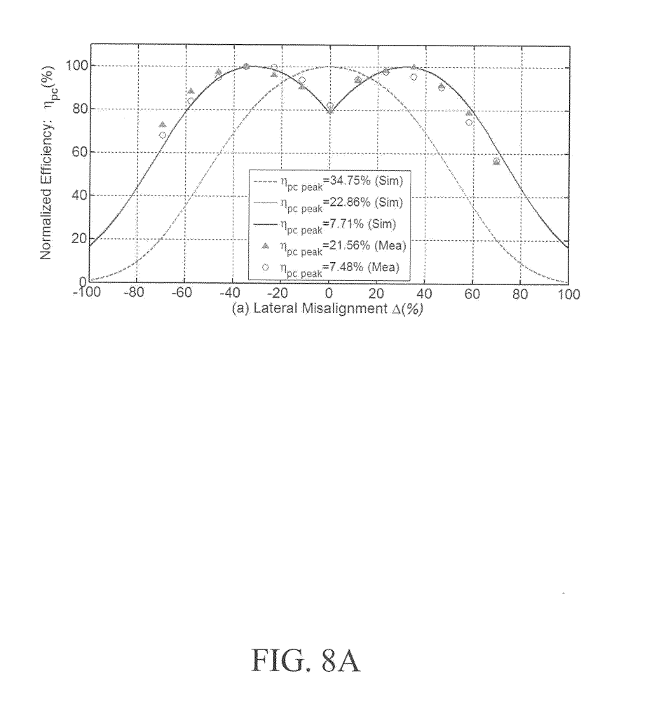

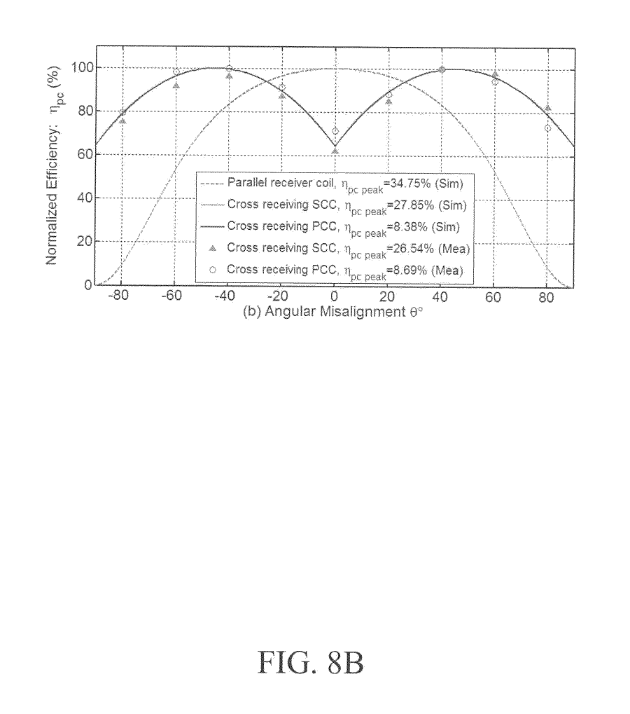

The change in percentage of η_{sc} and η_{pc} with properly chosen Cᵣ and R_{L} are similar and hence, only the results of i are presented here. FIGS. 8A and 8B illustrate the normalized efficiency under lateral or angular misalignments respectively, and the load resistance is 2185Ω.

Structures SCC and PCC have similar normalized efficiency curves, due to the same mutual inductance variation. Given the maximum efficiency variation is within 40% of respective peak efficiency, it can be seen from FIGS. 8A and 8B that the receiving coils can allow 70% absolute lateral misalignment and 90° absolute angular misalignment, while for single parallel receiving coil setup, the allowed misalignment ranges are around 45% and 60° , respectively only. What is more, it is important to note that under angular misalignment M and normalized efficiency with traditional design can fall to zero, but the receiver can always maintain above 60%. By comparing the results of efficiency with three different receiving coil structures, it is obvious that the additional orthogonal configuration offers a relatively constant normalized efficiency under a wide misalignment condition. Nevertheless, the trade-off for the new design is the increased coil size. Under the same length of wire used, the maximum power efficiency is generally lower than that of the single parallel structure. Some experimental data is shown in Table IV.

TABLE IV
THE EXPERMENTAL RESULTS OF M AND η_{PC} UNDER
LATERAL MISALIGNMENTS

| | Single | | Cross | | Cross | |
|---|---|---|---|---|---|---|
| | Parallel | | receiving | | receiving | |
| | receiving coil | | coil in series | | coil in parallel | |
| Δ/cm | M/μH | η_{pc}/% | M/μH | η_{pc}/% | M/μH | η_{pc}/% |
| 3.0 | 0.24 | 9.24 | 0.27 | 12.11 | 0.12 | 4.26 |
| 2.5 | 0.34 | 15.23 | 0.33 | 17.02 | 0.15 | 5.59 |
| 2.0 | 0.45 | 21.98 | 0.37 | 19.71 | 0.17 | 6.76 |
| 1.5 | 0.55 | 27.28 | 0.39 | 21.56 | 0.19 | 7.14 |
| 1.0 | 0.63 | 31.28 | 0.39 | 21.18 | 0.19 | 7.31 |
| 0.5 | 0.68 | 33.33 | 0.36 | 20.16 | 0.17 | 7.04 |
| 0.0 | 0.70 | 33.06 | 0.32 | 17.13 | 0.16 | 6.14 |
| −0.5 | 0.68 | 32.26 | 0.37 | 19.48 | 0.18 | 7.02 |
| −1.0 | 0.64 | 29.73 | 0.40 | 20.69 | 0.19 | 7.45 |
| −1.5 | 0.57 | 26.00 | 0.41 | 21.51 | 0.19 | 7.48 |
| −2.0 | 0.48 | 21.05 | 0.40 | 21.00 | 0.19 | 7.09 |
| −2.5 | 0.38 | 15.55 | 0.35 | 19.02 | 0.17 | 6.27 |
| −3.0 | 0.28 | 8.93 | 0.26 | 15.67 | 0.14 | 5.08 |

To achieve a higher efficiency practically, the quality factors can be increased by further reducing the winding resistance, which can reduced by optimizing the materials used, for the wires, the number of strands, etc.

By introducing orthogonal windings on the receiving coil, less variation of power efficiency against misalignments is achieved and hence, allowing a larger misalignment tolerant for inductive coupling coils. The trade-off of structure is the peak coupling coefficient will be lower, which in turn affect power efficiency. But on the other hand, power transfer efficiency also depends on the coil quality factors, so the efficiency profiles can be further improved by reducing the coil AC resistance.

Advantageously, the apparatus for transferring electromagnetic energy is operable to provide solution for wireless electromagnetic coupling in all aspect, including power transmission and wireless communication.

Without deviating from the spirit of the invention, the apparatus for transferring electromagnetic energy can be implemented to operate as energy link to power up and end-use-device, as well as a communication link to control and retrieve data of the same device, using the same apparatus. In some embodiments, the apparatus for transferring electromagnetic energy may be use solely or separately for energy link or communication link, and is not limited by the quantitative features as described in the example embodiments.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An apparatus for transferring electromagnetic energy comprising a coil arrangement operable to transmit magnetic flux to a receiver or to receive magnetic flux from a transmitter, wherein the coil arrangement includes a main coil and at least one auxiliary coil electrically combined with the main coil such that the combination of the main coil and the at least one auxiliary coil is arranged to alter an electromagnetic coupling between the coil arrangement and the transmitter or the receiver to increase an operation alignment range between the coil arrangement and the transmitter or the receiver.

2. An apparatus in accordance with claim 1, wherein each of the main coil and the at least one auxiliary coil is operable to transmit magnetic flux to the receiver or to receive magnetic flux from the transmitter.

3. An apparatus in accordance with claim 1, wherein the increased operation alignment range between the coil arrangement and the transmitter or the receiver includes an increased displacement and/or angular alignment between the coil arrangement and the transmitter or the receiver.

4. An apparatus in accordance with claim 1, wherein each of the main coil and the at least one auxiliary coil have different spatial orientations.

5. An apparatus in accordance with claim 1, wherein the electromagnetic coupling between the coil arrangement and the transmitter or the receiver defines an overall mutual coupling.

6. An apparatus in accordance with claim 5, wherein the electrical combination of the main coil and each of the at least one auxiliary coil is interchangeable depending on a misalignment condition between the coil arrangement and the transmitter or the receiver so as to maximize the overall mutual coupling.

7. An apparatus in accordance with claim 6, wherein the main coil and the at least one auxiliary coil each defines a plane, the planes being arranged to be defined by one or more intersections of the main coil with the at least one auxiliary coil.

8. An apparatus in accordance with claim 1, wherein the main coil and the at least one auxiliary coil are electrically connected in series.

9. An apparatus in accordance with claim 1, wherein the main coil and the at least one auxiliary coil are electrically connected in parallel.

10. An apparatus in accordance with claim 7, wherein the plane defined by the main coil is orthogonal to at least one of the plane defined by the at least one auxiliary coil.

11. An apparatus in accordance with claim 1, wherein the main coil and the at least one auxiliary coil are simultaneously energized.

12. An apparatus in accordance with claim 1, wherein the main coil and the at least one auxiliary coil each comprises at least one turn.

13. An apparatus in accordance with claim 1, wherein the main coil and the at least one auxiliary coil each resembles a circular, square, rectangular, triangular, polygonal, spiral or any irregular shape.

14. An apparatus in accordance with claim 1, wherein litz wires are used in the main coil and/or the at least one auxiliary coil.

15. An apparatus in accordance with claim 1, wherein the main coil and/or the at least one auxiliary coil is defined by a single core wire, multi core wire, printed circuit board (PCB) track or any combination thereof.

16. An apparatus in accordance with claim 1, wherein the coil arrangement defines a first inductance and a first resistance and the transmitter or the receiver defines a second inductance and a second resistance; and the coil arrangement is coupled with the transmitter or the receiver through a third inductance defined by the electromagnetic coupling between the coil arrangement and the transmitter or the receiver.

17. An apparatus in accordance with claim 1, wherein a load is connected to the coil arrangement when the coil arrangement is arranged to receive electromagnetic energy from the transmitter.

18. An apparatus in accordance with claim 17, wherein the coil arrangement is further connected with a capacitive component arranged to resonate with the first inductance of the coil arrangement on an operating frequency so as to increase an energy transfer efficiency between the coil arrangement and the transmitter.

19. An apparatus in accordance with claim 18, wherein the capacitive component is connected in series with the load.

20. An apparatus in accordance with claim 18, wherein the capacitive component is connected in parallel with the load.

21. An apparatus in accordance with claim 1, wherein each of the at least one auxiliary coil is transposed vertically, horizontally or both vertically or horizontally about an axis of the main coil.

22. An apparatus in accordance with claim 1, wherein the main coil and the at least one auxiliary coil have a spiral, solenoid or rectangular winding structure.

23. A wireless inductive link arranged to transfer electromagnetic energy comprising a receiver and a transmitter, wherein at least one of the transmitter or the receiver is an apparatus in accordance with claim 1.
